(19) United States
(12) Patent Application Publication
(10) Pub. No.: US 2017/0235449 A1
(43) Pub. Date: Aug. 17, 2017

(54) Personalized Multimedia Autographing System

(71) Applicants: David Harris Walters, Rockville, MD (US); David Michael Brooks, Crofton, MD (US)

(72) Inventors: David Harris Walters, Rockville, MD (US); David Michael Brooks, Crofton, MD (US)

(21) Appl. No.: 15/425,264

(22) Filed: Feb. 6, 2017

Related U.S. Application Data
(60) Provisional application No. 62/294,341, filed on Feb. 12, 2016.

(51) Int. Cl. G06F 3/0483; G06Q 30/06; G06F 3/0488; G06F 3/0481; G06F 3/0482

(52) U.S. Cl. CPC G06F 3/0483; G06F 3/04817; G06F 3/0482; G06F 3/0488; G06Q 30/0601

(57) ABSTRACT

This invention provides the end-to-end control, networking, and data management for the 1.) identification of event signings, 2.) generation of push invitations to such events, 3.) personalization of ebooks via reader-author collaboration to embed Personalized Multimedia Autographs (PMAs) into the ebook or other media, 4.) event line control allowing readers to browse the bookstore or mingle while waiting for collaboration with the author during these events, 5.) capability for the readers and author to discuss the event on social media after the readers have registered for the event enabling the author to tailor his/her comments at the vent to the readers' interests; 6.) synchronization and archival of the PMA among all of the reader's devices, 7.) integration of special services such as reserved seating as well as food and beverage that may make invitations to such events in the future very exclusive. This invention may be implemented using any one of several embodiments depending upon the retailer's business environment.

### 1 RELATED APPLICATION

This application claims priority to U.S. Provisional patent application No. 62/294,341, filed Feb. 10, 2016, entitled Personalized Multimedia Autographing System, incorporated herein by reference.

### 2 BACKGROUND OF INVENTION

The introduction of ebooks has thoroughly disrupted the publishing industry and forced the closing of many thousands of “bricks and mortar” bookstores. It has provided phenomenal benefits to readers including: a) more comfortable reading experience using a small tablet sized device with a very sharp, controllable sized font rather than a large, bulky, heavy hardcover book, b.) immediate on-line access to dictionaries, c.) near instant availability of ebook sample chapters, d.) on-line access to information related to the ebook on the Internet using embedded URL references and search engines, e.) elimination of the need for physical storage space for books, f.) lower cost, g.) constant reading quality over time compared to hardcover books whose pages become discolored and spines break or crack.

One disadvantage of ebooks is that the publishing industry has not yet adopted techniques for autographing ebooks by their authors even though ebooks open new opportunities for personalizing autographs. Furthermore, even current procedures for the autographing hardcover books involve readers waiting in lines—time readers could better spend browsing in the “bricks and mortar” store and perhaps making a purchase. Therefore, a comprehensive solution is needed to address the autographing ebooks and hardcover books for the modern publishing industry because existing solutions do not provide the services that readers desire.

### 3 PRIOR ART

The following is a tabulation of some prior art that presently appears relevant:

U. S. Patents

| Patent | Kind | Issue | |
|---|---|---|---|
| Number | Code | Date | Patentee |
| 8,880,602 | B2 | 2014 Nov. 4 | Dougherty et al. |
| 8,898,587 | B2 | 2014 Nov. 25 | Patterson et al. |
| 6,845,361 | B1 | 2005 Jan. 18 | Dowling |
| 7,505,474 | B2 | 2009 Mar. 17 | Walter |
| 0,133,283 | A1 | 2008 Jun. 5 | Backer et al. |
| 0,047,332 | A1 | 2014 Feb. 13 | Liu et al. |
| 8,520,025 | B2 | 2013 Aug. 27 | Patterson et al. |
| 8,712,857 | B1 | 2014 Apr. 29 | Adornato et al. |
| 8,315,909 | B1 | 2012 Nov. 20 | Barker |
| 8,533,003 | B2 | 2013 Sep. 10 | Mueller et al. |
| 7,729,945 | B1 | 2010 Jun. 1 | Katz et al. |

U.S. Patent Application Publications

| Publication | Kind | Publication | Applicant of Cited |
|---|---|---|---|
| Number | Code | Date | Document |
| 2003/0018524 | A1 | 2003 Jan. 23 | Fishman et al. |
| 2006/0136344 | A1 | 2006 Jun. 22 | Jones et al. |

### Other Publications and Sources

Autograph LLC, website: “www.autography.com”. Describes the features of their book signing service.
Authorgraph website: “www.authorgraph.com”. Describes the features of their book signing service.

The ebook is rapidly replacing the printed physical book. It is much more efficient to download and carry an ebook then to produce, purchase and carry a physical book. There are still people that prefer a physical book due to limitations of the ebook. It is desired that the reader should be able to do everything with an ebook that can be done with a physical book in order to fully replace physical books. In particular, there is a need to be able to autograph and otherwise customize the book as part of a book signing with the author. This allows the reader to be able to interact with the author who they admire and be able to associate the customization with that interaction.

While Dougherty et al. describes a method to add an autograph to an ebook, it does not solve the issue of interaction between the bookstore, author and reader. There is a need to be able to coordinate this activity to make it easy, efficient and enjoyable for all parties. It also does not address how physical book signing coexists with ebook signings. It also does not address how the autograph is stored and distributed across multiple user devices.

Paterson et al. describes methods to identify whitespace within an ebook and insert an autograph in an ebook, however it also does not provide a complete solution. Issues not addressed include coordination of the parties at the bookstore and sharing the customization across multiple devices.

An existing solution on the market from Authograph is a remote (not in person) solution to sign ebooks in which the autograph is in a separate document. The user requests an autograph online and at a later time receives a separate document containing the autograph. It does not deal with the physical book store environment or the interaction of all of the parties. The solution does not support multimedia. No solution is provided to manage the autograph—this is left to the reader. Only certain books are supported based on inclusion on the website and the author participation.

Autography supports a solution that allows the reader to remotely request an autograph from the author when an ebook is purchased. The interaction is not real time and online only. This solution while providing an embedded autograph, is not interactive and does not provide the user with a live experience at the bookstore with the author. No provision is provided to autograph a previously purchased ebook. The solution is not universal in that the book can only be purchased at a site that is linked to Autography, and thus the selection of books is limited.

Existing solutions do not allow the electronic customization to be easily stored and retrieved by the reader when the ebook is re-downloaded or loaded to another platform. This feature is needed to make it easier to maintain and retrieve the data over a long period of time.

Currently if the reader is interested in a book signing, he would have to search the internet to find where a book signing will occur and then show up unannounced and wait in line in some cases for hours. This is not a user friendly way of either identifying upcoming book signing or interacting at the book store. None of the current solutions address this issue.

Dowling describes virtual queueing solutions for a physical resource using smart phones, but does not address the specific needs of managing a queue for autographing in a book store with a mixture of physical books and ebooks.

Walter describes methods to manage a queue using smart phones to communicate with the person in the queue. Again, however, it does not provide methods to manage a queue for autographing books in a book store with a mixture of physical books and ebooks.

Backer et al. describes methods to manage a queue using smart phones to communicate with the person in the queue when it's their turn. Again, however, it does not provide methods to manage a queue for autographing books in a book store with a mixture of physical books and ebooks.

Liu et al. describes methods to attach multimedia data to an ebook. However, it does not provide a method to store this data in a seamless way that can use the current infrastructure provided by ebooks sellers that does not modify the copyrighted ebook.

While Patterson et al. teaches methods to attach video and audio to an ebook. It also does not address how this data is stored and synchronized across multiple user devices.

Existing solutions do not provide the services that customers desire. This invention addresses these needs as described below.

### 4 SUMMARY OF INVENTION

This invention using electronic means provides the reader with the capability to identify a book signing event of interest; register for the event; purchase an ebook license, hardcover book, as well as related special services or products; capture a media data object necessary to generate a Personalized Multimedia Autograph (PMA); generate a PMA for an ebook without modifying the copyrighted ebook content in a convenient, efficient, and personal manner; store the PMA in an on-line bookstore; display the PMA on demand at a location in the ebook selected by the reader; ensure that the PMA is synchronized among all of the reader's devices; and seamlessly interoperate with hardcover book signing events. A novel push capability is built into the invention to invite readers to book signing events when they are browsing an on-line bookstore. In cases when it is inconvenient for the author to participate in an in-store event signing, the remote embodiment of the invention enables the reader and author to perform these functions by collaborating over the Internet.

In addition, the invention is designed to provide special services for event signings of the future. These services may include food, beverage, and memorabilia, as well as support for ticketed events, either complimentary or paid. It is envisioned that some ticketed events may become very exclusive compared to current book signing events. For example, ticketed book signings may charge premium prices, but include deluxe services such as cocktails and dinner with the author in addition to the PMA.

To implement these capabilities, this invention provides the end-to-end control structure and data management system. Key features of the invention are: portability among user devices, authenticity of author signings, security to ensure only valid use by owners of ebook licenses, security to prevent spoofing by unauthorized individuals, push invitations to readers, synchronization among reader devices, use of imaging, video, and audio technology to generate the PMA, archival of personalized ebooks, and use of standard ebook formats.

This invention is intended to accommodate all of these cases in a manner that meets readers' needs and is profitable to bookstores, publishers, and authors.

### 5 BRIEF DESCRIPTION OF FIGURES

FIG. 1 depicts the System Diagram for the On Premise Embodiment during the Pre-Event phase.

FIG. 2 depicts the System Diagram for On Premise Embodiment during the Event Signing phase when readers arrive at the local bookstore to particpate in the event.

FIG. 3 depicts a generic hardware block diagram for a smartphone embodiment for a 1 Reader Device.

FIG. 4 depicts a hardware block diagram for a tablet computing device embodiment for the 3 Local Control Device.

FIG. 5 depicts a generic hardware block diagram for a Cloud Server embodiment for the 3 Master Control Device and the 4 On-Line store and Vault (OLV).

FIG. 6 depicts a processing system in more detail for a Cloud Server embodiment for the 3 Master Control Device and 4 On-Line store and Vault.

FIG. 7 depicts a software block diagram for the 1 Reader Device.

FIG. 8 depicts a software block diagram for the 2 Master Control Device.

FIG. 9 depicts a software block diagram for the 3 Local Control Device.

FIG. 10 depicts a software block diagram for the 4 On-Line store and Vault.

FIG. 11 depicts collection of data for and the generation of the 211 Event Signing Database.

FIG. 12 depicts the Pre-Event phase involving database queries, ebooks or hardover purchases, and event registration activities.

FIG. 13 depicts the Registration Confirmation Message Display as shown on the 1 Reader Device

FIG. 14 depicts the OLV issuing a “push invitation” to a local signing event to the reader.

FIG. 15 depicts the Event Phase involving reader and author collaboration to capture and personalize a media data object, and then generate and store the PMA.

FIG. 16 depicts the Next Message display on the 1 Reader Device indicating the author is ready to collaborate with the reader to generate a PMA.

FIG. 17A depicts an e-Book Page displaying a PMA Icon. This is the default view when the PMA is not displayed.

FIG. 17B depicts an ebook page displaying the PMA after tapping the icon. The PMA is hidden when the reader taps the X in the upper right corner of the PMA in this embodiment.

FIG. 18 depicts the Remote embodiment where the reader and author collaborate over the Internet. In this case, the author is co-located with the 3 Local Control Device.

### 6 DETAILED DESCRIPTION

The objective of this invention is to provide the lifecycle services necessary for the full collaboration of reader and author enabling the insertion of a PMA into an ebook during on-premises book signings for ebooks. It is also compatible with traditional autographing of hardcover books.

The lifecycle begins with the invention using electronic means to capture the announcements of event signings and then display this information for readers; it continues through the storage, archival, and potential retrieval of the PMA. The geographical range of the invention supports bookstores or other entities holding event signings for readers across the United States.

Rather than being a sequential series of steps, the operation of this invention involves parallel activities. At the top level, it consists of Signing Events Data Collection activity performed in parallel with many local Event Signings at various stages of progress. The Ongoing Signing Data Collection activity is a periodic activity and uses electronic means to retrieve event signing data (book title, genre, author, ISBN, data of signing, time, location, special services) from participating bookstores and other entities, enter the data into a database, format it for display, and respond to user queries to the database.

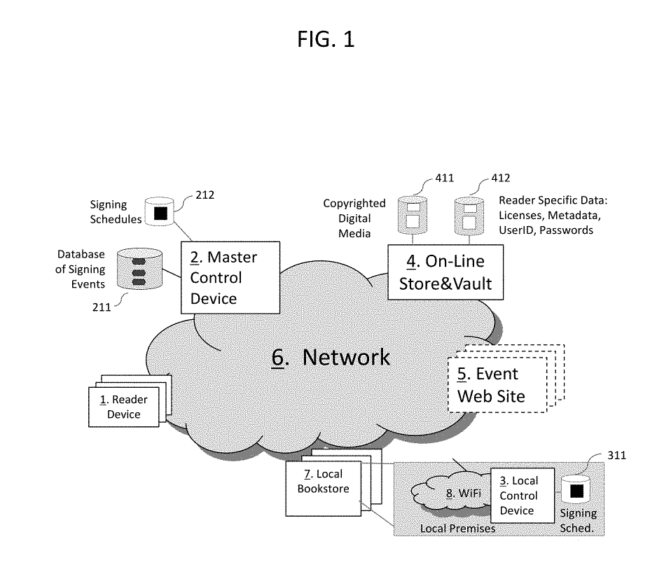

Each local Event Signing activity is organized into three phases: Pre-Event, Event, and Post-Event. FIG. 1 depicts the invention embodiment during the Pre-Event phase while the periodic Signing Events Data Collection activity is being performed in parallel. As shown in the figure, the invention system elements comprise: 1 Reader Devices, 2 Master Control Device, 3 Local Control Device resident on premises in the local bookstore conducting the signing event, 4 OLV, 5 Event Web Sites interconnected by a 6 Network, 7 Local Bookstore premises, 8 WiFi in the local bookstore.

The 5 Event Web Sites are the existing sites on the Internet used by bookstores and other entities conducting signing events to advertise these events. The 6 Network is the Internet used by consumers and businesses in the United States for commercial or personal use to perform email, file transfer, web access for such activities as social media, e-commerce, and other electronic media activities. The 8 WiFi is the IEEE 802 standard wireless local area network.

Also, FIG. 1 depicts the data elements associated with this embodiment. These elements comprise: 211 Database of Signing Events and 212 Signing Schedules resident at the Master Control Device; 311 Local Signing Schedule for the 3 Local Control Device at each local bookstore; and 411 Copyrighted ebooks and 412 Reader Specific Files resident at the 4 OLV, On-line Store & Vault, including the Multimedia Notes and Highlights files storing the PMA.

The Multimedia Notes and Highlights file is an extension of traditional Notes and Highlights files to accommodate PMAs. In this invention, it is a text file of ebook metadata consisting of:

1. User Inserted Notes
Formatted text
Location for insertion of such notes into the ebook

2. User Inserted Coloring of ebook Text or Objects
Selection of color
Beginning location and end location of color into the ebook

3. PMA Insertion
Location for insertion of PMA into the ebook
Pointer to PMA file(s), i.e., the media data object with the personalized annotations.

4. Other currently supported data.

The Pre-Event phase begins when the event is entered into the database for display to the reader. The activities include:
Querying the Event Signing Database by the reader to identify events of interest,
Re-selling of ebook licenses and hardcover books,
Checking the license of ebooks to validate ownership,
Registering validated readers at Signing Events to obtain PMAs,
Integrating the registration of the signing event into the reader's personal calendar (so reminder messages will be generated),
Providing special services to readers that are event specific and may include reserved seating at Signing Events, pre-paid or complimentary food and beverage service (e.g. coffee or wine service at the event), or author memorabilia (e.g., tee shirts, engraved pen and pencil sets).

The Pre-Event phase ends and the Event Phase begins when the 3 Local Control Device begins execution of a protocol welcoming readers to the signing event by electronic means as described below.

The special services are one feature of the invention designed to attract ebook readers to “bricks and mortar” stores. These services enable the bookstore owner to offer a unique service to readers that will increase reader “traffic” into the store resulting in increased sales.

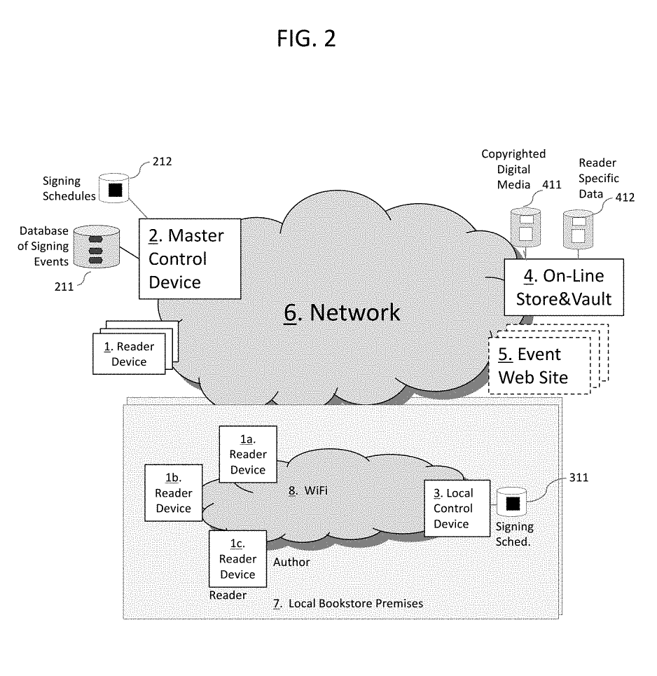

FIG. 2 depicts the Event Phase that begins when Readers (denoted by Readers 1a, 1b, and 1c) have arrived at the store to meet the author and participate in the event. The activities include:
Welcoming the reader to the event by electronic means (text or WiFi message),
Providing a special service such as reserved seating or food and beverage service,
Notifying the reader when the author is ready to sign his/her ebook by electronic means (text or WiFi message or page) so it is unnecessary for the reader to wait in line,
Allowing the reader to select the location in the ebook where the PMA shall be inserted either by pointing or menu selection,
Capturing the PMA media data object to be used for the PMA,
Annotating the media data object by the author in a personalized manner as requested by the reader to generate the PMA,
Generating and storing the PMA in Notes and Highlights file,
Storing the PMA at the on-line book store,
Synchronizing the PMA on all of the reader's reading devices.

The invention applies to readers who own hardcover books and have smartphones, but they will obtain physical autographs rather than PMAs. However, they will have the benefits of being notified when the author is ready to sign their book and will not have to wait in line.

After the reader and author have collaborated to generate a PMA as described above, the Event Phase has been completed for that reader. The Post Event activities include:
Displaying an icon at the location in the ebook selected by the reader where the PMA is to be displayed,
Displaying the PMA on demand when the icon is actuated by tapping,
Hiding the PMA upon request by tapping a selected location of the PMA.

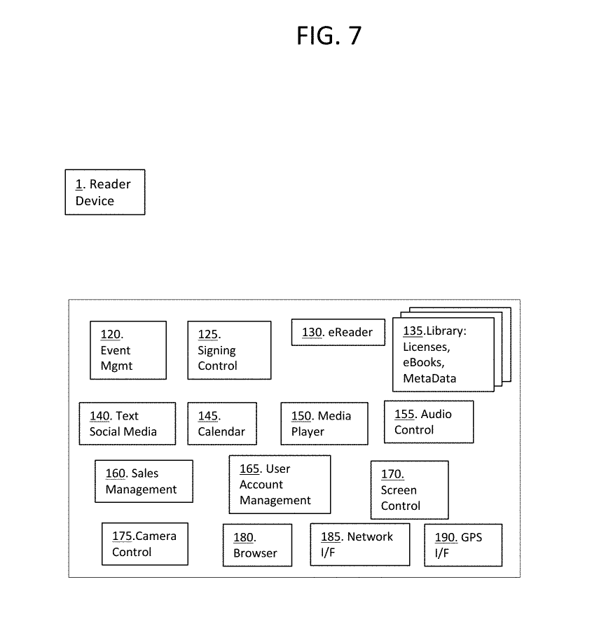

When the reader later opens the ebook associated with a particular Signing Event on another of his/her devices, the 130 eReader software component, depicted in FIG. 7, will automatically download the updated Multimedia Notes and Highlights File with the PMA from the 4 OLV. This ensures that PMA is available on all of the reader's devices.

This invention is directly applicable to ebooks that have published according to open standards, but it also applicable to ebooks that have published with Data Rights Management Protection. In the latter case, the invention would require access to the protected copyrighted material to insert the PMA.

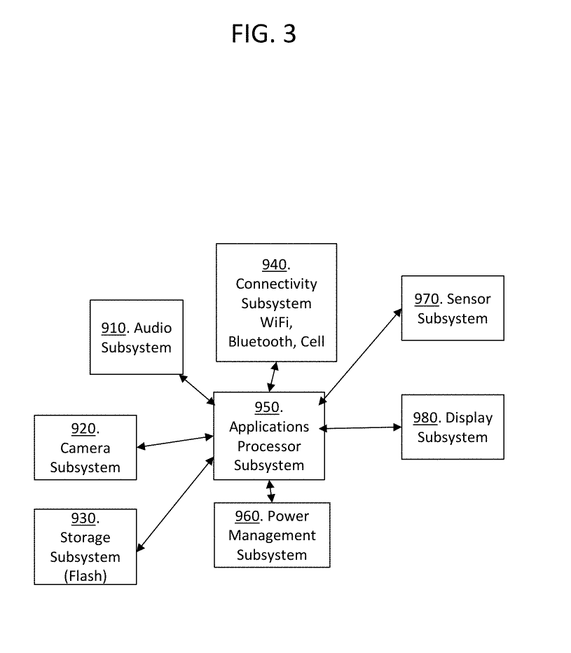

FIG. 3 depicts Smartphone hardware blocks as commonly implemented. The 910 audio subsystem provides functionality that includes a microphone device to capture, format and input audio and a playback system with a speaker to play audio. The 920 camera subsystem includes cameras (typically both front and rear) that allow video capture, still frame images and video conferencing. The 930 storage system allows appropriate data to be persistently stored to the device. This data includes the operating system (OS), applications (Apps), and multimedia including ebooks, and other user data. The 940 connectivity subsystem provides all connectivity to the outside world. Examples of connectivity include USB, Wi-Fi, cellular, and Bluetooth. The 950 application processor provides a processing engine to run all the code on the smart phone including the OS and Apps. The Apps include ebook readers as well as the proposed apps to allow PMAs to be implemented. The 960 power management subsystem provides hardware to charge the battery, manage heat and reduce power consumption to extend the battery life. The 970 sensor subsystem provides physical inputs to the platform that are used by the OS and apps. Examples of sensor data include GPS, compass data, orientation, light, temperature and well as finger print reader for authentication. Finally, the 980 display subsystem implements the hardware to display video and enable the touch screen. It is typically a LCD display with touch sensing and the associated drivers. Several accessories may be used to facilitate the signing process. A commercially available “selfie stick” may be used to facilitate taking a picture with the author. Additionally, a stylus can be used to facilitate the actual inscription/autograph on the touch screen. This will provide a higher resolution than can be achieved via a finger for instance.

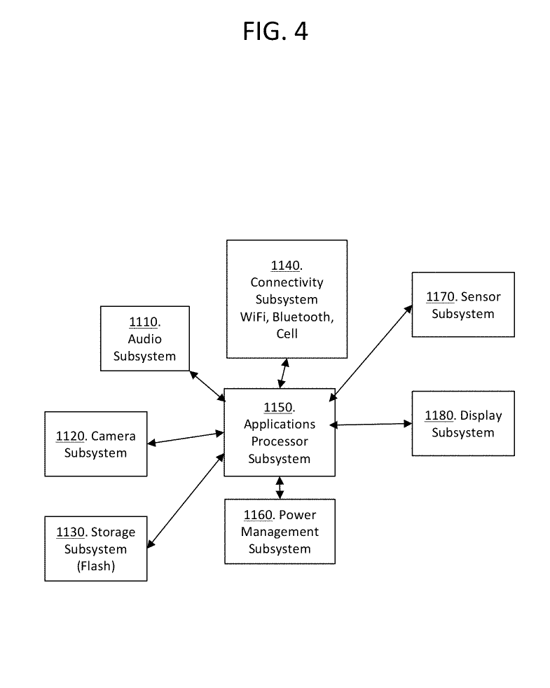

FIG. 4 depicts tablet hardware blocks as commonly implemented. The 1110 audio subsystem provides functionality that includes a microphone device to capture, format and input audio and a playback system with a speaker to play audio. The 1120 camera subsystem includes cameras (typically both front and rear) that allow video capture, still frame images and video conferencing. The 1130 storage system allows appropriate data to be persistently stored to the device. This data includes the operating system (OS), applications (Apps), and multimedia including ebooks, and other user data. The 1140 connectivity subsystem provides all connectivity to the outside world. Examples of connectivity include USB, Wi-Fi, cellular, and Bluetooth. The 1150 application processor provides a processing engine to run all the code on the smart phone including the OS and Apps. The Apps include ebook readers as well as the proposed apps to allow PMAs to be implemented. The 1160 power management subsystem provides hardware to charge the battery, manage heat and reduce power consumption to extend the battery life. The 1170 sensor subsystem provides physical inputs to the platform that are used by the OS and apps. Examples of sensor data include GPS, compass data, orientation, light, temperature and well as finger print reader for authentication. Finally, the 1180 display subsystem implements the hardware to display video and enable the touch screen. It is typically a LCD display with touch sensing and the associated drivers.

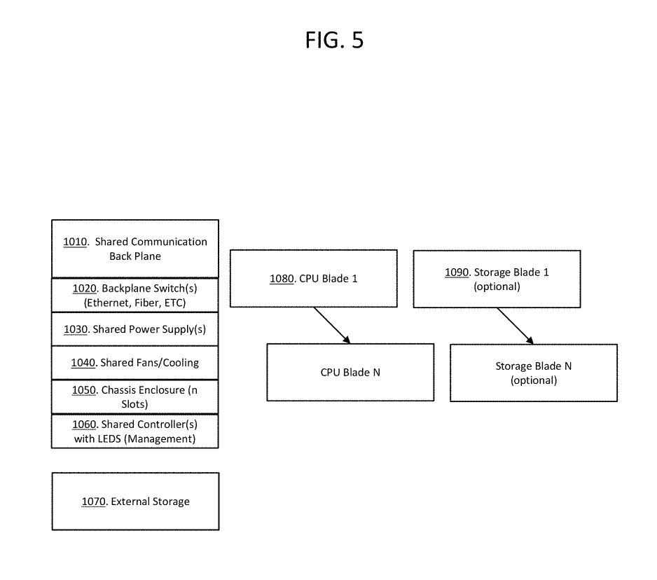

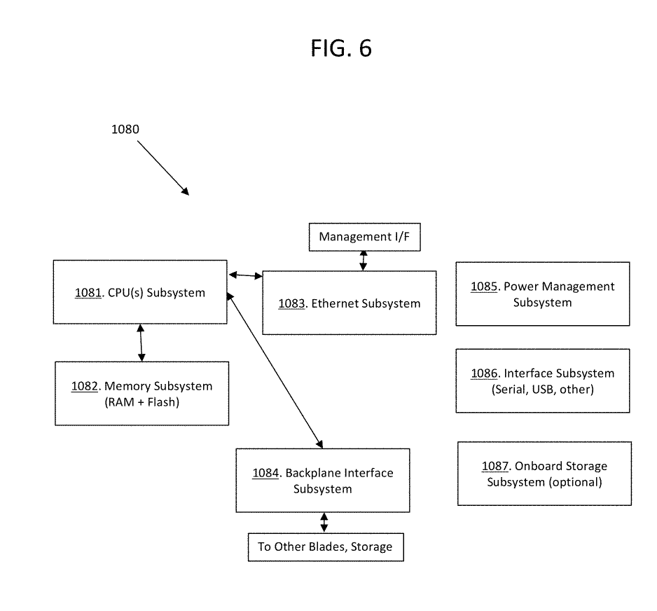

FIGS. 5 and 6 depict a typical Cloud Computing platform. These figures show one embodiment with many variations possible. The cloud platform is a large number of servers distributed geographically for redundancy and reliability. FIG. 5 shows a single server of which there are many spread across locations. The server consists of a 1010 shared backplane that is used to interconnect the 1080 server blades and optionally 1090 storage blades. A 1020 backplane switch is provided to switch data between the blades and can use Ethernet, fiber or other physical interconnects for that purpose. A 1030 shared power supply(s) provides appropriate power to the blades and other components and would be usually redundant to protect against failure. There is also a 1040 shared cooling subsystem consisting of sensors and fans to cool the server. The 1050 physical rack (chassis enclosure) provides slots to hold the blades. There is a shared controller 1060 that manages the rack and provides diagnostic information such as statistics and faults. The 1060 shared controller also provides configuration and control of the rack. The rack can hold n blades which are either 1080 CPU blades or 1090 storage blades. The 1070 external storage is used to replace or supplement the internal storage of data.

As shown in FIG. 6 each 1080 server blade is a single board computer. Its is composed of a 1081 CPU subsystem which has one or more general purpose processors. The 1082 memory subsystem contains both non-volatile storage such as flash for long term storage and DRAM for temporary storage and code execution. The 1083 Ethernet subsystem provides an interface to the management subsystem as shown in FIG. 6. The 1084 backplane interface connects the blade to other blades and external devices. The 1085 power management subsystem manages the power on the blade providing the proper voltages and minimizes power consumption and manages board temperature. The 1086 interface subsystem provides other interfaces such as serial, USB, and proprietary interfaces. Finally, the 1087 onboard storage optionally provides non-volatile storage that is internal to the blade.

FIG. 7 depicts 1 Reader Device software implemented as a smartphone app comprising the invention specific app components and commercial components readily available in all smartphones. The major app software components of this invention residing in the 1 Reader Device are the 120 Event Management component to execute the pre-event and event management activities for the reader and the 125 Signing Control component to execute the reader-author collaboration activities at the signing event.

The scope of 120 Event Management activities comprise the querying of the 211 Event Signings Database in the 2 Master Control Device to identify events of interest to reader; registering for such events; interfacing with the 145 Calendar component to generate reminders; interfacing with 160 Sales Management component when the reader desires to purchase either an ebook or hardcover book; coordinating the signing schedule with the 3 Local Control Device at the Signing Event; and providing status to the 2 Master Control Device.

The scope of the 125 Signing Control activities comprises generating the PMA, selecting the location for the PMA to be inserted into the ebook, interfacing with 175 camera control for capture of the image, interfacing with 170 screen control for capture of the personalized annotation, and storing the PMA in the reader's ebook Notes and Highlights file.

The 1 Reader Device software also includes 130 ebook Reader with 135 ebook Library consisting of ebook licenses, ebooks, and ebook metadata. This software is similar to existing eReaders, but it is enhanced to read and store PMAs. Specifically, the 130 eReader component utilized in the invention retrieves the PMA from the reader's Notes and Highlights file to display the PMA in the ebook at a location of the reader's choice. It hides the PMA, when the reader taps an X on the PMA. With this capability, the copyrighted ebook is not changed.

The 160 Sales Management software component is an e-commerce front-end enabling the reader to purchase ebooks and hardcover books via the 4 OLV and to either purchase or obtain special services directly from the local store.

The 165 User Account Management is a user account system provides traditional account management functions for reader access to the 2 Master Control Device and 4 OLV.

Other software components comprising the 1 Reader Device are readily available on all smartphones: 140 Text and Social Media, 145 Calendar, 150 Media Player, 155 Audio Control, 170 Screen Control, 175 Camera Control, 180 Browser, 185 Network Interface, and 190 GPS Interface.

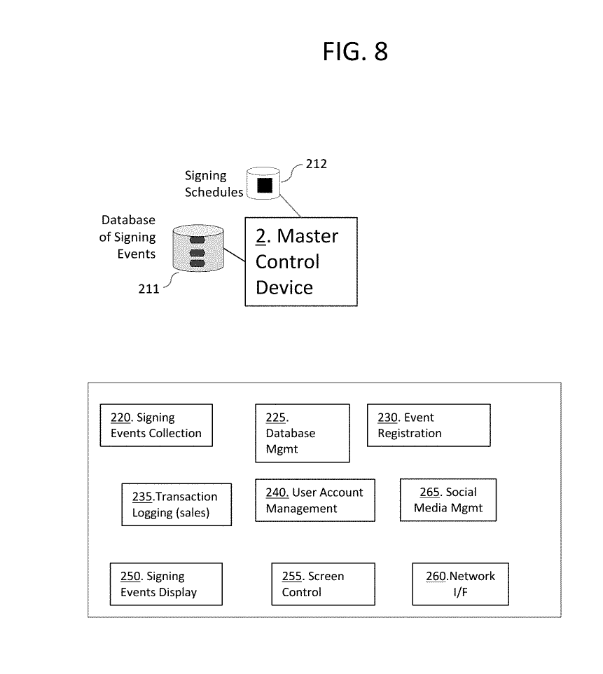

FIG. 8 depicts 2 Master Control Device software components comprising the invention components, commercial components readily available in all tablets, and data elements 211 Database of Signing Events and 212 Signing Schedules. The invention software components comprise 220 Signing Events Collection, 230 Event Registration, 235 Transaction Logging, 240. Reader Account Management, and 250 Signing Events Display. The novel invention components described whose operation are described below are the 220 Signing Events Collection and 230 Event Registration components. The 225 Database Management System component with the supporting 211 Database of Signing Events also responds to queries from the 4 OLV to match reader locations and signing events during the generation of “push invitations” to signing events. Implementing a novel feature of the invention, the 265 Social Media Management component automatically relays text messages among readers and authors prior to and during the signing event.

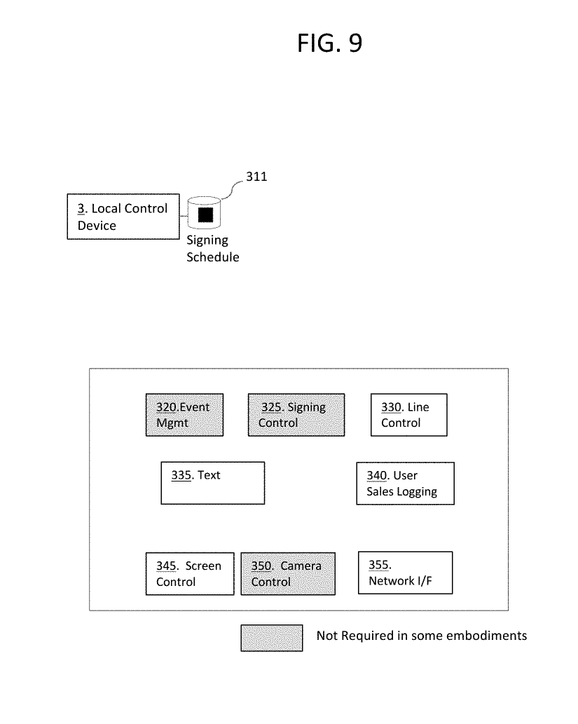

FIG. 9 depicts 3 Local Control device software components comprising the invention components, commercial components readily available in all tablets, and 311 Local Signing Schedule(s) for the local store. It maintains the signing schedule for each reader for each of its event scheduled for the local bookstore. During the event, it manages the schedule of signings. The major invention software components comprise 330 Line Control Event Management and 340 Sales Logging. It also includes commercial components 335 Text, 345 Screen Control, 350 Camera Control, and 355 Network Interface. In some embodiments the 3 Local Control Device software components may also include 320 Event Management and 325 Signing Control such as the Remote Embodiment described in Section 9. In this embodiment, the 3 Local Control Device is responsible for key functions such as line control and author-reader collaboration.

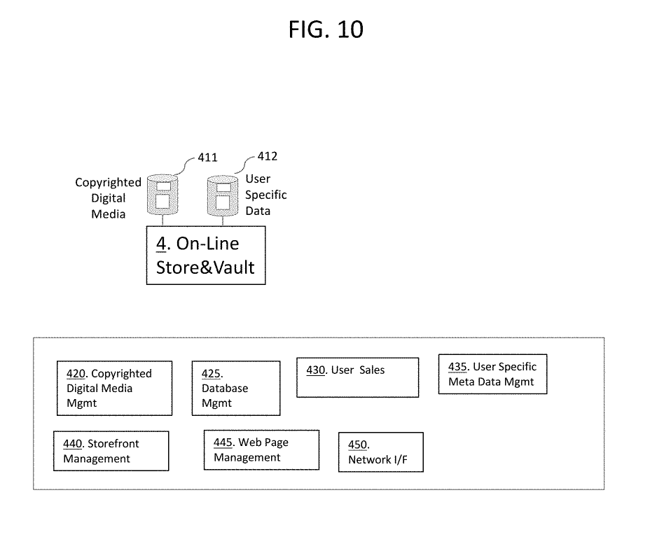

FIG. 10 depicts the 4 OLV software components comprising the invention components, commercial components, and 411 Copyrighted Digital Media and 412 Reader Specific Data. For the invention, the 4 OLV requires changes only to the 430 User Sales component to perform license validation and 440 Store Front Management for generation of “push invitations” and to the 412 Reader Specific Data to accommodate the PMA in the aforementioned Multimedia Notes and Highlights file.

### 7 OPERATION

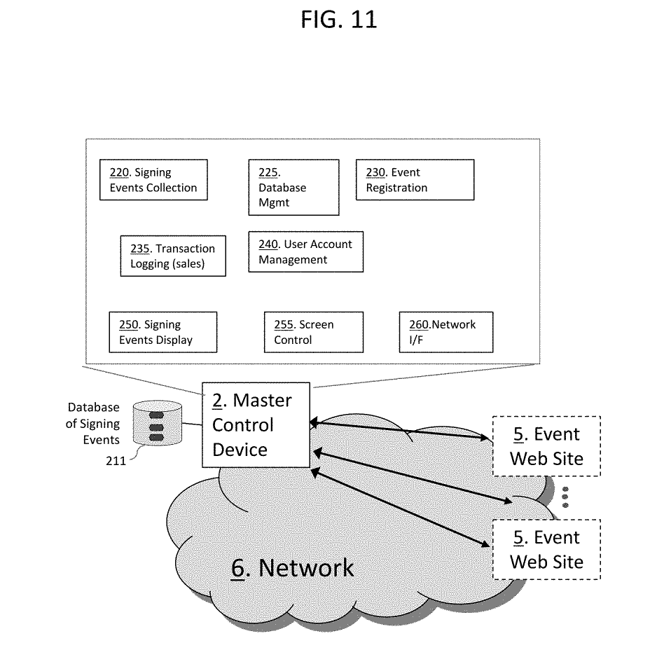

FIG. 11 depicts the periodic Event Data Collection Operation where the 2 Master Control Device queries each of the 5 Event Web sites to determine the current signing events using electronic means. This step of the invention is implemented using standard network protocols with configured URLs for the 5 Event Web Sites that display signing events.

The 220 Signing Events Collection module in 2 Master Control Device transmits a request through the 6 Network using standard protocols to retrieve the current event signing page from each 5 Event Web Site. In response, the 5 Event Web Site transmits an event file describing the current schedule of event signings to the 2 Master Control Device. The 220 Signings Events Collection modules in the 2 Master Control Device will parse this file to determine the relevant data to be stored in the 211 Database of Signing Events; it checks for new events and updates of events already stored in the database and forwards relevant data to the 225 Database Management System module for storage in the 211 Database of Signing Events.

These data elements include but are not limited to ebook title, subtitle, ISBN, author(s), date of signing, time of signing, place of signing, address of signing, related graphic media objects, and (available) Special Services.

In parsing the received event file, the 2 Master Control Device may detect additional URLs, e.g., the full set of events could not fit one Web page. The 2 Master Control Device will repeat this process for all URLs detected in the parsing.

The 2 Master Control Device will query all 5 Event Web Sites during one update. The timing and frequency of periodic updates are configurable parameters of the invention. The parameters should be set so that the event signing data is reset on a daily basis with minimal performance impact on the performance experienced by the reader.

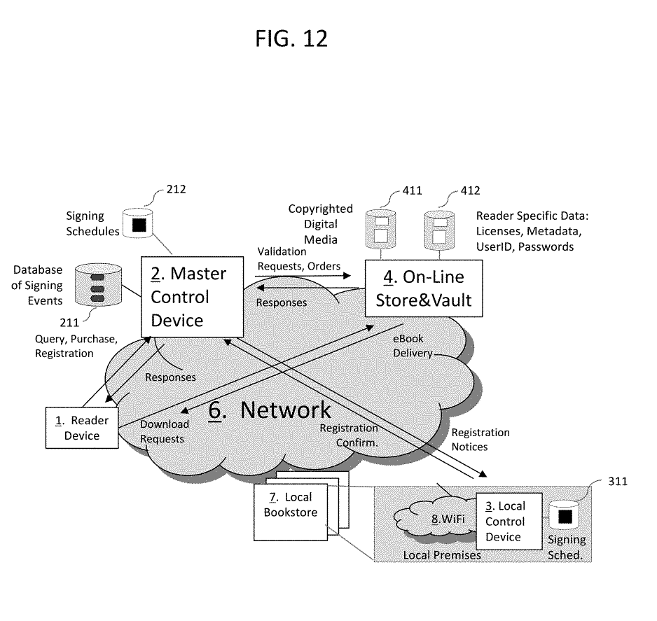

FIG. 12 depicts Pre-Event Operation beginning when the reader opens the app on his/her 1 Reader Device causing the 165 User Account Management component to sign in the reader automatically and begin execution of the 120 Event Management component displaying the signing menu options. The reader then enters menu data with parameters comprising geographic area of signing locations, range of dates, and book genre(s) of interest.

After the reader enters such menu data, the 120 Event Management component in the 1 Reader Device receives the input via 170 Screen Control. The 120 Event Management component processes the inputs and transmits a request message through the 6 Network via the 185 Network Interface using standard network protocols to the 2 Master Control Device to query the 211 Event Signings Database. The 250 Signing Display component in the 2 Master Control Device receives the request and queries the 211 Signing Events Database to retrieve the relevant data and generates and formats a response message. It transmits the response through the 6 Network via the 260 Network Interface using standard protocols to the 1 Reader Device for display to the reader with options to register for the events, purchase the books in either ebook or hardcover format, and/or obtain special services. Upon identifying an event of interest, the reader registers for the event in order to obtain a PMA with or without special services. The reader may or may not purchase a book for the event because the reader may already own an ebook license. In addition, the reader may make additional queries.

If the reader has selected the option to purchase either an ebook license or hardcover book associated with the signing event and to register for a signing event, an ecommerce transaction is performed with 4 OLV via the 2 Master Control Device. In this case the 160 Sales Management component in the 1 Reader Device extracts the relevant user information from the 165 User Account component and displays the information to the reader via the 170 Screen Control component allowing the reader to edit the data. The reader enters his/her 4 OLV user account and credit information to enable the transaction, e.g. userID, social mediaID (optional), password, credit card information, or payment data.

The 160 Sales Management component then executes the ecommerce transaction to purchase the book and register for the signing event by transmitting a message through the 6 Network via the 185 Network Interface using standard ecommerce protocols to the 230 Event Registration component in the 2 Master Control Device. The 230 Event Registration first performs the ecommerce transaction by extracting the purchase parameters from the message and transmitting a purchase message over the 6 Network to the 4 OLV.

The 430 User Sales component in the 4 OLV executes the transaction by authenticating the reader UserID-password, approving payment, and checking the order for any errors. Inventory would be checked for hardcover orders. It then replies to the 2 Master Control Device with its approval for the purchase and for the ebook provides a URL enabling the reader to retrieve the ebook via the 6 Network. The 2 Master Control Device forwards the response to the 1 Reader Device over the 6 Network. The 235 Transaction Logging component in the 2 Master Control Device logs the transaction.

Then the 230 Event Registration component proceeds with the signing event registration. It generates an event registration message and transmits it through the 6 Network to the 330 Line Control component in the 3 Local Control Device. This message includes the reader name, userID, optionally security parameters (public encryption key of 1 Reader Device), and event parameters (author name, book title, date, time).

The 3 Local Control Device stores the registration in the 311 (Local) Signing Schedule file and confirms the registration by transmitting a registration confirmation message to the 230 Event Registration component. This message provides the reader with a registration confirmation number, social media identifiers (e.g., Twitter name, hashtag) for the event, and other event or facility information (Name, Address, GPS co-ordinates of the bookstore, security parameters (public key) of 3 Local Control Device).

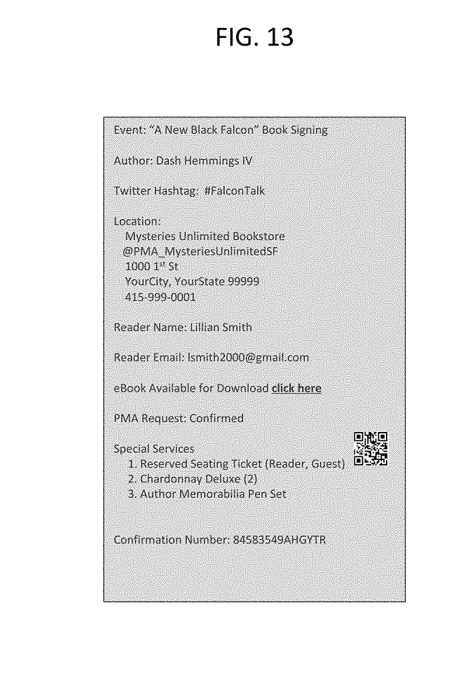

The 2 Master Control Device stores the registration in 212 Signing Schedule database. The 230 Event Registration component then transmits a Registration Confirmation message via electronic means, shown in FIG. 13, to the 120 Event Management component in the 1 Reader Device. The Registration Confirmation message includes ebook title, author, location, date, time, social media identifiers (e.g., Twitter name, hashtag), reader name, reader email address, link to download the ebook (if purchased), confirmation of special services (if ordered) and registration confirmation number. It may also include a validation mechanism such as a QR code.

Note after receiving the Registration Confirmation message, readers and the author may discuss the event on social media such as Twitter. This is a very powerful capability because it enables readers to submit questions and comments to the author prior to the event. After reviewing this input, the author can tailor his/her comments at the event to the interests of the readers in attendance. Furthermore, the author may even take questions via social media during a question session at the event.

The 120 Event Management component adds the event to the reader's personal 145 Calendar for generation of reminder notices to the reader. The app also sets a timer to wake up the 120 Event Management component on the day of the event to check for arrival at the local bookstore and begin execution of the Arrival-Welcome protocol. This timer is set a configurable number of minutes before the scheduled time of the event.

If the reader has selected any Special Services, e.g., reserved seating, complimentary coffee, parameters for these services are included in the registration confirmation message. If the special services require pre-payment such as food and beverage, an e-commerce transaction is performed to select the item and execute the electronic transaction and then such parameters are included in the message.

For ebook purchases, the reader downloads the ebook directly from the 4 OLV to the 1 Reader Device as one would normally do for a traditional ebook purchase. Hardcover books are shipped through normal delivery means or picked up at the bookstore when getting the PMA.

If the reader only selects a signing event of interest to attend and obtain a PMA (no ebook purchase), the reader selects the Register option on the 1 Reader Device display. This requires validation of the reader's ebook license.

For Signing Event Registration, the 120 Event Management component processes and forms an Event Registration message from Account Information and Event Announcement and transmits the message through the 6 Network via the 185 Network Interface using standard protocols to the 230 Event Registration in the 2 Master Control Device. Upon receipt at the 2 Master Control Device, the 230 Event Registration component checks whether the ebook license must be validated. Since the reader has not selected the purchase option in this case, the 230 Event Registration component will continue with ebook license validation by transmitting a license validation request message through the 6 Network via the 185 Network Interface using standard protocols to the 4 OLV. The 430 User Sales component in the 4 OLV validates that the reader holds a valid license of the ebook and responds with a message to the 230 Event Registration component indicating that the reader holds a valid license.

After the ebook license has been validated, the 230 Event Registration continues with Event registration as described above. The reader may repeat these actions for additional signing events.

After having registered for a signing event, the reader may select the location for insertion and identifying icon for the PMA during either in the Pre-Event phase or the Event phase by opening the app on the smartphone and selecting the insert PMA menu option. The 125 Signing Control component via 170 Screen Control provides the reader options to either provide textual input page number, x-y co-ordinates (start: upper left, end: lower left) or to open the ebook using the 130 Reader component and point to the desired insertion location. The 125 Signing Control stores the requested insertion location (and size) where the PMA will be inserted after the reader and author collaborate to generate the PMA.

The 125 Signing Control component via 170 Screen Control provides the reader options to select the available icons by menu display or to import a graphic image that may be used as the icon. After the reader makes a selection, the 125 Signing Control component stores the requested selection.

In some cases, the reader may not find any signings in the local area. In these cases, the reader may order a signed hardcopy from a non-local bookstore and have it shipped. The purchase and registration functions as describes above; a bookstore rep will serve as a proxy to obtain the author signature. The reader may have the signed copy shipped to a home address or to a local address or to a local bookstore (to obtain free shipping and increase traffic to the store).

After the reader has completed registration for an event, the reader may use social media to engage the author and other readers who will be attending the event. After receiving the Registration Confirmation message, the 140 Text Social Media component in 1 Reader Device is configured to receive text messages based on the 2 Master Control Device social media name for the event sponsor and the event identifier (hashtag). Also, after the reader has registered, the 265 Social Media Management component in the 2 Master Control Device is configured to listen to social media text messages pertaining to the event from registered readers, i.e., denoted by the reader's social media name and event identifier (hashtag). When such a reader generates such a message, and it is received by the 2 Master Control Device, the 265 Social Media Management component will then relay them. Readers and the author can review and respond engaging in a conversation about the event. Also, the author can tailor his/her comments at the event to the interests of the readers gleaned during the conversation.

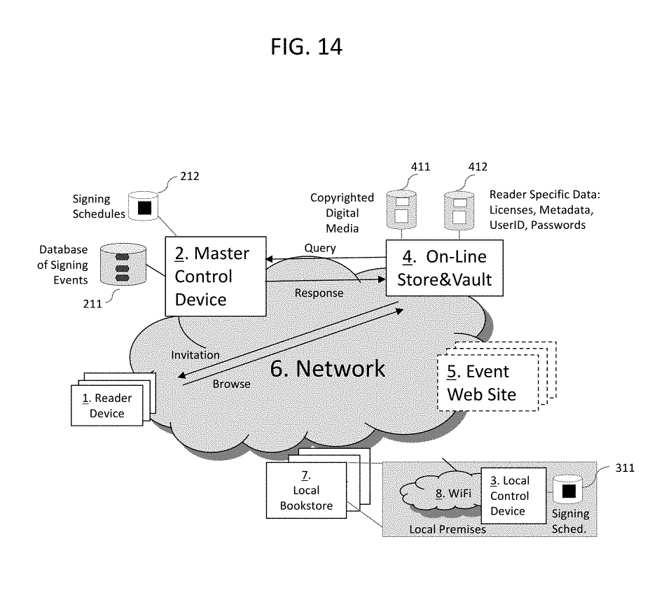

FIG. 14 depicts a reader browsing in the 4 OLV using the web browser in his/her 1 Reader Device to identify books of interest. In this case the reader identifies a book of interest and clicks on it. If the reader is signed into the 4 OLV, the 4 OLV may be able to determine the reader location from the reader profile. Then it sends a query to the 2 Master Control Device to determine if there are event signings within 25 miles (a configurable parameter) of the reader's location for the book selected by the reader. If there are any such signings, the 2 Master Control Device will send a response message to the 4 OLV. Then the 4 OLV will send a “Push Invitation” message inviting the reader to these event signings.

If the reader is interested in any of these Event Signings, the reader will invoke the registration process for event signings as described above.

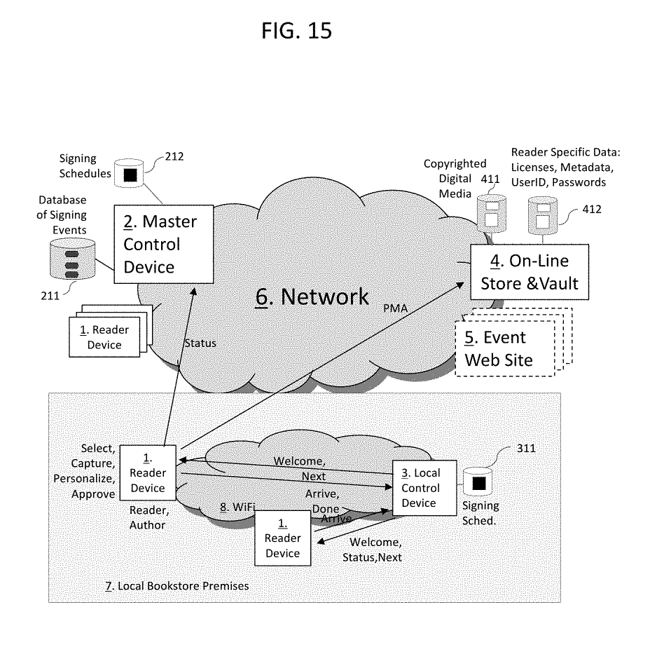

FIG. 15 depicts Reader-Author Collaboration beginning when the readers arrive at the premises of the local premises. As noted above, a timer is set to open the 120 Event Management component a configurable number of minutes before the event. The 120 Event Management component accesses 190 GPS Interface of the 1 Reader device to determine its current location and compare it with the location of the co-ordinates of the 7 Local Bookstore conducting the Signing Event. When the difference is within a configurable tolerance, the 120 Event Management component concludes that the reader has arrived at the event and begins execution of the Arrival-Welcome protocol.

The 120 Event Management component in the 1 Reader Device invokes the appropriate communications media (texting, Bluetooth) to execute the Welcome-Arrival protocol based upon the Bookstore facilities information provided in the Registration message. It transmits an Arrival Message using this media with the reader's Name, UserID, Password, Event Registration Confirmation Number, Reader Device Hardware ID, Social Media ID of the Signing Event (e.g., Twitter Name, Hashtag), and 1 Reader Device GPS Position to the 3 Local Control Device. The password may be encrypted with bookstore's public encryption key provided in the registration confirmation message.

The 330 Line Control component in the 3 Local Control Device receives and processes this message. It updates the 311 local schedule indicating that reader has arrived and responds with a Welcome Message. This message fixes the unique 1 Reader Device that will be used to generate the PMA and provides the WiFi parameters, optionally encrypted with the public key of the Reader Device. The 1 Reader Device is then able to access the 7 Local Bookstore 8 WiFi Network.

The 3 Local Control Device also assigns and transmits the Line Control Number (LCN) in the Welcome Message to the 1 Reader Device. The LCN establishes the reader's place in queue for signing, e.g., if a reader is assigned an LCN value equal to 3, it will be the third reader to collaborate with the author in the generation of a PMA.

The 3 Local Control Device also alerts bookstore personnel to provide any Special Services to the reader, e.g., provide a purchased hardcopy book, usher to reserved seating, or provide food and beverage service.

After arriving at the bookstore, the reader will go to the “pick up central” location in the bookstore to obtain items purchased via through the special services capability. To obtain these items, the reader uses the 1 Reader Device to display the Event Signing Registration Confirmation Message for bookstore personnel. As described above, the information in this message include the reader's name, email, confirmation number, and the items purchased. The message may also include a mechanism e.g., bar or QR code, for electronic processing so that the bookstore may use electronic means rather than manual reading to validate the order.

Bookstore personnel will then provide the items, e.g., books, beverages, and food. For some more exclusive events, they may also provide tickets and usher readers to their seats.

Readers may configure their app to opt out of using the Arrival-Welcome protocol. In this case, upon arriving at the bookstore, the reader displays the Registration Confirmation message to a bookstore rep and the reader will be manually entered into the queue for a PMA and provided and special services that have been purchased.

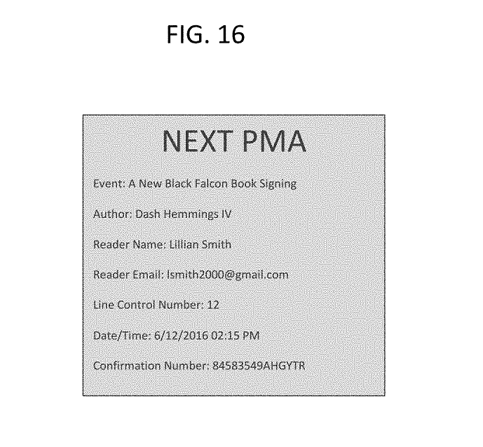

When the signing period of the event begins, typically after the author has finished a short talk and answered questions, the 330 Line Control component in the 3 Local Control Device sends text messages to readers who have registered to obtain PMAs and physical autographs. The reader who is scheduled first receives a NEXT message advising the reader to meet the author in the signing area; it will also generate a NEXT message display, shown in FIG. 16, on the reader's smartphone with the event identification information, reader's name, line control number, and time stamp. The transmission time of the Next message establishes the beginning of an Authentication Window during which the aforementioned unique 1 Reader Device is the only one permitted to generate a PMA with this author. The authentication period ends when the 3 Local Control Device receives a status message receive indicating the PMA generation has been completed.

Other readers will receive Status messages indicating their relative position in the signing queue allowing them to browse in the bookstore or enjoy the available food and beverage service. When the reader's position nears the top of the queue, he/she will receive a “heads up” status message indicating collaboration with the author is imminent. When the reader's position is at the top of the queue and the author is ready to collaborate, the reader receives the NEXT message. At this time, the reader moves to the signing area to meet the author.

When the reader and author meet in the signing area, the reader uses 1 Reader Device to show the aforementioned NEXT message display to the author validating the reader for the next signing. Then the reader and the author begin collaboration. They use the 1 Reader Device to capture the media data object to be used for the PMA, in one embodiment a JPEG photograph, another an MPEG video clip. The 125 Signing Control component captures the media data object with its interface to 175 camera control. This may include attachments such as a “selfie stick” enabling the reader to easily capture a photo or video of the reader and the author. In an alternative embodiment [See Section 7 on Alternative Control Embodiments], a bookstore representative may hold the camera and capture the media object more easily depicting the reader and author.

Once the media object is captured, the reader may use the 125 Signing Control component to invoke various utilities to resize or optimize the coloring of the object. In some cases, the reader may want to take several photos or videos and pick a preferred one for use in the PMA.

After the preferred media data object has been selected, the reader and author collaborate on the personalization. The author enters the personalization inscription typically using a stylus that is captured by 125 Signing Control via 170 Screen Control and integrated with the media data object to form the PMA. It is then displayed to the reader for approval.

For a photo media data object, the author may autograph the photo with the agreed upon inscription. For a video media data object, the reader and author may collaborate to create an introductory frame that would precede the video clip when played. Its contents may comprise: title, time, date, date, location, names, author signature, and inscription with suitable background coloring and effects.

If the reader approves, the 125 Signing Control stores the PMA in the Multimedia Notes and Highlights file (by reference) for this ebook. It also transmits the PMA and the updated Multimedia Notes and Highlights files over the 6 Network and 8 WiFi using standard network protocols via the 185 Network Interface to the 4 OLV.

The 125 Signing Control component updates the status of PMA by transmitting a message to the 3 Local Control Device and 4 Master Control Device. The 330 Line Control component in the 3 Local Control Device invites the next reader to meet the author in the signing area by transmitting a Next message and updates the status for all other readers waiting for PMAs or hard cover autographs via Status message.

In cases where the reader does not approve of the PMA, the generation of the PMA is repeated. Several iterations are allowed where the maximum number is a configurable parameter.

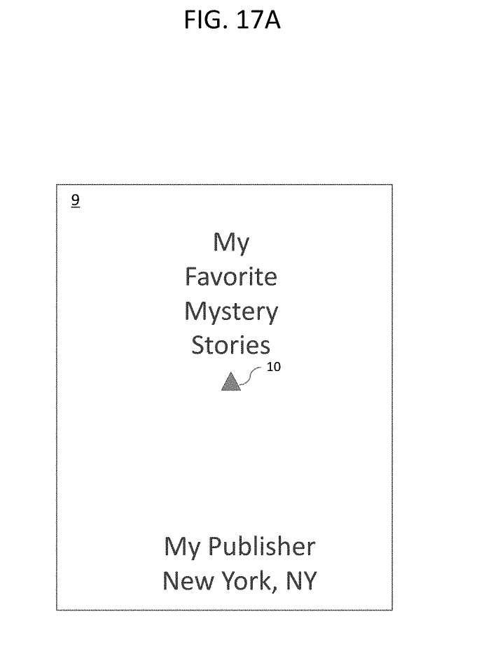

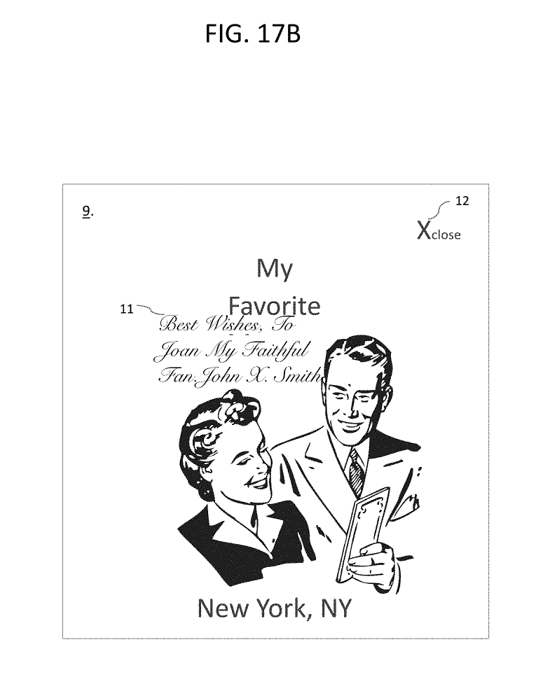

FIG. 17A and FIG. 17B depicts a sample ebook with an embedded PMA. First FIG. 17A depicts a view of an 9 ebook page using the 130 Reader software component in the 1 Reader Device after the PMA has been inserted with the 10 orange triangle icon denoting where the exact location of insertion—in this case, the location is on the title page. When the reader touches the 10 orange triangle icon, the 130 Reader component retrieves the 11 PMA, a personalized photo, from the Multimedia Notes and Highlights file and displays it to the reader via 170 Screen Control as shown in FIG. 17B.

In this example the 11 PMA overlaps some parts of textual information on the title page. When the reader touches the large 12 X, the 130 Reader component hides the 11 PMA and displays the title information and 10 orange triangle icon via 170 Screen Control. Note again, the 11 PMA is stored in the ebook Multimedia Notes and Highlights file and ebook copyrighted material is unchanged.

### 8 ALTERNATIVE READER DEVICE EMBODIMENTS

The invention may be implemented using different embodiments of the 1 Reader Device depending upon invention phase and reader preferences. For example, rather than a smartphone, the reader may use a desktop computer or a laptop computer as a 1 Reader Device to access the 211 Event Signings Database in order to identify events of interest. In this case, the 1 Reader Device (a PC) would include a Web 180 browser to access the database.

The reader could still use a smartphone to capture the PMA during the Event Phase. Alternatively, the reader could choose to use a tablet or laptop computer during the Event Phase depending upon personal preferences.

### 9 ALTERNATIVE CONTROL EMBODIMENTS

In some situations, it may be more convenient for a third person (other than the reader or the author) to hold and control the device capturing the media data object. Such person may be the bookstore representative who may capture the media data object using the 3 Local Control Device.

Therefore, in this embodiment the 350 Camera Control component and 325 Signing Control component are resident in the 3 Local Control Device in order to generate and personalize the PMA.

The advantage of this embodiment is the physical ease of capturing the PMA. It provides the equivalent service of the recommended embodiment.

### 10 CLOUD EMBODIMENT

In this embodiment, the 3 Local Control Device is removed from the System Architecture. Then the Bookstore representative uses a web browser on a smartphone to a.) access the signing schedule in the 2 Master Control Device b) execute any control commands. This provides an equivalent service to the recommended embodiment.

The advantage of this embodiment is that it minimizes the data processing and storage infrastructure on the local bookstore. However, it is dependent on having network connectivity to the 2 Master Control Device.

### 11 REMOTE EMBODIMENT

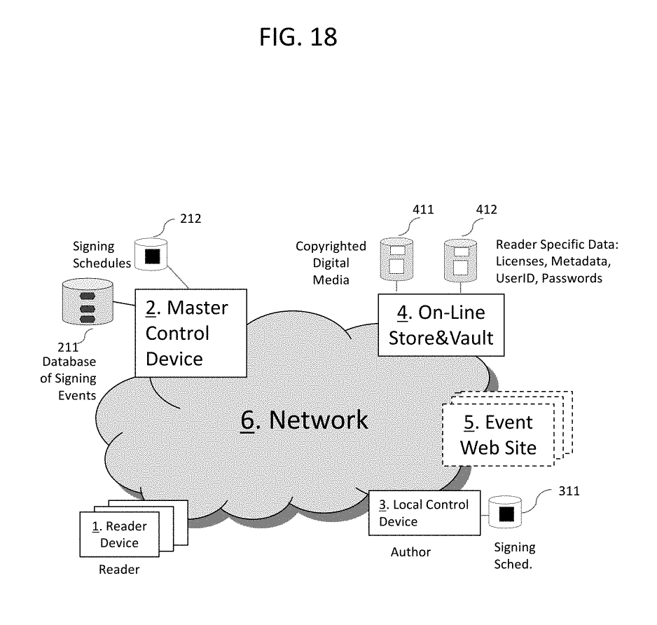

FIG. 18 depicts the Remote embodiment where it is not practical for the reader and the author to meet in order to generate a PMA. Remote signing events are included in the Signings Event database, but denoted as remote. Readers may register for them like they would register for on premise events. Readers would also select the location for the PMA and the type of icon.

When the signing window begins, the reader and author would discuss the personalization details using electronic means. The media data object could be an image or a video of the author.

As shown in the figure, the author is co-located with 3 Local Control Device that utilizes the 320 Event Management component to schedule the signings of individual readers. It also uses the 350 Camera Control component and 325 Signing Control component to generate the PMA.

Hybrid embodiments are possible. For example, the remote embodiment and the cloud embodiment could be combined with the author using only a smartphone. This is a very attractive alternative because it minimizes the software infrastructure for the author.

This embodiment is a workaround and does not provide the full functionality of the recommended embodiment because it does not capture a media data showing both the reader and the author.

### 12 NON WIFI COMMUNICATIONS EMBODIMENTS

Almost all bookstores will have WiFi networks, but some may not be so equipped. In this case network communications will be provided by texting for all messages and cellular for transmission of all media data objects.

This embodiment provides an equivalent service, but charges may be incurred and performance may be degraded.

### 13 ALTERNATIVE MEDIA EMBODIMENTS

While this description of the invention (as described in Sections 4 and 5) applies to specific photo and video data objects captured using a camera for ebooks, it can be extended to apply to other media applications including but not limited to the electronic album art of audio books, audio (MP3) and video (DVD) products.

### 14 CONCLUSIONS

This invention closes the business loop between retailers, publishers, and authors to provide a practical solution for the personalization of ebooks. It provides an end-to-end control, networking, and data management solution for the identification of event signings; capability for the readers and author to discuss the event on social media after readers have registered for the event allowing the author the tailor his/her comments at the event to the readers' interest; push invitations to identify events; multimedia personalization of ebooks; line control so readers can browse the bookstore or mingle while waiting for collaboration with the author; synchronization and archival of the PMA among all of the reader's devices; special services such as reserved seating as well as food and beverage.

This invention may be implemented using any one of several embodiments depending upon the business retailer's business environment. In the basic case described in this patent application, processing and storage of scheduling data may be resident at the local bookstore. However, it is envisioned with cloud computing technology processing and storage may evolve to the cloud for many retailers. Very often a smartphone will be used as a reader device, but a laptop or tablet device may also be used for collaboration with the author during PMA generation. If it is not convenient for the reader and author to physically meet, there is a remote embodiment of the invention.

While the simplest case of this invention is the embedding of a photo into an ebook, it also covers the embedding of other media such as audio or video into an ebook. Analogously, the invention also includes the embedding of such media into cover art of audio books, DVDs and MP3 albums.

While signing events have been traditionally viewed as free and open events, the special services feature of this invention provides the framework to make signing events the exclusive, paid events of the future. For example, paid book signing events may charge premium prices, but include deluxe services such as cocktails and dinner with the author in addition to the PMA.

In summary, this invention combines a novel set of ideas not previously available to retailers, publishers, and authors providing them new and promising business opportunities.

What is claimed:

1. A computer implemented method for creating a PMA, personalized multimedia autograph, comprising the steps:
a. Allowing a reader to specify a location in an ebook where the PMA shall be displayed, capture a media data object, enable the collaboration of a reader and an author to personalize the object, and subsequently allow the reader to display the PMA on demand using electronic equipment.
b. Performing PMA service management prior to an ebook signing event enabling the readers to determine a schedule of signing events and to register for such events to obtain the PMAs and special services via electronic means.
c. Performing PMA service management during ebook signing events enabling readers to request the PMAs via electronic means, to notify the readers via electronic means when the author is ready to personalize their books, to update a service status via electronic means when the signing is completed for each reader, and to collaborate with the authors to generate the PMA via electronic means.
d. Storing the PMA data in an OLV, on-line store and vault, to enable display and retrieval of the PMA on all of the reader's devices including after ebook archival.
Whereby providing the reader a more convenient, personal, timely method for obtaining a personalized autographed ebook.

2. A computer implemented method of claim 1 wherein creating the PMA comprises a.) the reader specifying a location in the ebook that the PMA shall be inserted by pointing to a location or providing a textual input b.) selecting an icon to designate the location in the ebook c.) capturing a media data object by c.1) the reader or the author, or third person using a camera or other media equipment or c.2) third person using the camera or other media equipment d.) the reader and the author adding a signature and a caption to personalize the PMA e.) the reader and the author capturing the PMA during an authentication window on the unique reader device to ensure that the PMA is authentic f.) the reader modifying and then approving the PMA g.) the reader and the author repeating the process as necessary to meet the reader approval.

3. A computer implemented method of claim 2 wherein selecting the icon to designate the location for insertion of the PMA comprises a.) providing menu choices on the computing device display: i.) a standard icon) ii.) an ebook genre icon options representative of the ebook classification iii.) a reader import option, b.) the reader selecting an icon type from the menu on the computing device display or the reader importing any external graphic image suitably scaled to be used as the icon via electronic means, c.) providing storage of the selection by electronic means.

4. A computer implemented method of claim 1 wherein on demand display of the PMA comprises a.) tapping or clicking the icon and the PMA will be displayed on the reader's device at the location specified by the reader overlapping any ebook text or other content b.) tapping or clicking a section of the PMA hides the PMA and the icon reappears.

5. A computer implemented method of claim 1 wherein performing the PMA Service Management prior to the ebook signing events via electronic means comprises of: a.) responding to the readers' queries to an event signing database based on author, title, location date, time, and other parameters in the database, b.) fulfilling orders to purchase both ebooks and hardcover books requested by the reader and executing electronic payments with the on-line store and vault c.) establishing the validity of a reader ebook license or hardcover ownership by checking the reader ebook license number and an user ID pair versus a list of valid license ID pairs stored in the on-line store and vault, d.) registering the readers who are holders of valid ebook licenses for the specific signing events conducted by local bookstores and other entities to obtain the PMAs or hardcover signings, e.) in cases where a fee is charged for the PMA, executing an electronic financial transaction between the reader and the on-line store and vault to charge the fee, f.). electronically notifying the local control device by placing the readers' names and the user IDs in the local signing schedule to be serviced when the author begins the signing period of the event, g.) entering registration events into a reader's personal calendars so a reminder notice for the reader may be generated, h.) providing special services to event registrants such as reserved seating at the event, complimentary coffee.

6. A computer implemented method of claim 1 wherein the PMA service management during the ebook signing events comprises: a.) managing reader registration notices and the PMA requests received prior to the event via electronic means b.) registering the readers and responding to the PMA requests for the event via electronic means who have not registered prior to the event including validating the ebook licenses and executing any electronic financial transactions necessary to obtain the PMAs, c.) manual insertion in special cases for customers without cell phones, d.) when the signing period of the event begins, notifying the first reader for signing via electronic means that the author is ready to personally autograph the reader's book e.) the reader and the author collaborate during a unique authentication window time period during when it is guaranteed only a unique reader-author PMA is generated f.) the process repeats as the readers and the author collaborate to generate the PMAs, g.) electronically notifying readers as to how many PMAs have been completed and how long it will be until they will be serviced, h.) electronically notifying the reader for the next signing via a heads up alert that he/she is about to be serviced after the author completes the current collaboration), i.) electronically notifying the reader via a NEXT message when the author is ready to collaborate for the generation of the PMA, j.) signings may include hardcover books, but they will only include author autographs.

7. A computer implemented method of claim 1 for storing the PMA data in a MNH, multimedia notes and highlights file independent of the copyrighted ebook to enable display and retrieval of the image on all of the reader's devices including after archival comprises a.) identifying the position in the MNH file for storage of the PMA b.) insertion of the PMA c.) transmission to the on-line store and vault d.) storage at the on-line store and vault.

8. The computer implemented method of claim 1 wherein is extended to other information media including but not limited to the electronic album art of audio books, MP3 audio and DVD video products.

9. The computer implemented method of claim 1 for performing PMA service management wherein it is extended to enable issuing push invitations for local signing events, books and other products and services of interest to the readers while they are browsing books of interest in the on-line store inventory and enabling the readers to register for such events and buy other books, products or services if they desire.

10. A PMA, personalized multimedia autograph, electronic system for creating a PMA in an ebook or other type of media, comprising:
a. A reader computing device with an attached input subsystem, one such embodiment is a touchscreen, that a reader uses to specify a location in the ebook where the PMA shall be displayed, a photo or a video camera to capture a media data object, the reader computing device that enables the collaboration of the reader and an author to personalize the PMA object, and a display which is part of the reader computing device which subsequently allows the reader to display the PMA on demand.
b. A master control server computing device with means to perform PMA service management prior to an ebook signing event enabling the readers to determine a schedule of signing events and to register for the events to obtain the PMAs and special services.
c. A local or master control server computing device with means to perform the PMA service management during the ebook signing events enabling the readers to request the PMAs via electronic means, to notify the readers when the author is ready to personalize their books, to update a service status when the signing is completed for each reader, and to collaborate with the authors to generate the PMA.
d. A storage subsystem containing persistent memory which in one embodiment is part of an on-line server computing device which can store the PMA data in an OLV, on-line store and vault, to enable display and retrieval of the PMA on all of the reader's devices including after ebook archival.
Whereby providing the reader a more convenient, personal, timely method for obtaining a personalized autographed ebook.

11. The PMA electronic system of claim 10 wherein creating the PMA comprises a.) the input subsystem of the reader computing device for the reader to specify where in the ebook the PMA shall be inserted by pointing to a location or providing a textual input b.) the input subsystem of the reader computing device to select an icon to designate the location in the ebook c.) the camera device to capture the media data object by c.1) the reader or the author, or third person using the camera or other media equipment or c.2) third person using the camera or other media equipment d.) the input device for the reader and the author to add a signature and a caption to personalize the PMA e.) the reader and the author capturing the PMA during an authentication window on the unique reader device to ensure that the PMA is authentic f.) the input subsystem of the reader computing device for the reader to modify and then approve the PMA.

12. The input and the persistent memory subsystems of the reader computing device of claim 11 wherein selecting the icon to designate the location for insertion of the PMA comprises a.) providing menu choices on the reader computing device display: i.) a standard icon) ii.) an ebook genre icon options representative of the ebook classification iii.) a reader import option, b.) the reader selecting an icon type from the menu on the reader computing device display or the reader importing any external graphic image suitably scaled to be used as the icon via electronic means, c.) the storage subsystem of the reader computing device that saves the selection.

13. The PMA electronic system of claim 10 wherein the display subsystem that is part of the reader computing device that supports on demand display of the PMA comprising a.) tapping or clicking the icon on the display so the PMA will be retrieved from the reader's computing device's storage subsystem and displayed on the reader's computing device at the location specified by the reader overlapping any ebook text or other content b.) tapping or clicking a section of the PMA on the reader's computing device display hides the PMA and the icon reappears.

14. The PMA electronic system of claim 10 wherein the master control server computing device performs the PMA service management prior to the ebook signing events via electronic means comprises of: a.) responding to readers' queries to an event signing database based on author, title, location date, time, and other parameters in the database, b.) fulfilling orders to purchase both ebooks and hardcover books requested by the reader and executing electronic payments with the on-line store and vault c.) establishing the validity of a reader ebook license or hardcover ownership by checking the reader ebook license number and an user ID pair versus a list of valid license ID pairs stored in the on-line store, d.) registering readers who are holders of the valid ebook licenses for the specific signing events conducted by local bookstores and other entities to obtain the PMAs or hardcover signings, e.) in cases where a fee is charged for the PMA, executing an electronic financial transaction between the reader and the on-line store and vault to charge the fee, f.) electronically notifying the local control device by placing the readers' names and the user IDs in a local signing schedule to be serviced when the author begins the signing period of the event, g.) entering registration events into a reader's personal calendar so a reminder notice for the reader may be generated, h.) providing special services to event registrants such as reserved seating at the event, complimentary coffee.

15. The PMA electronic system of claim 10 wherein the local or the master control server computing device performs the PMA service management during the ebook signing events comprises: a.) managing reader registration notices and PMA requests received prior to the event via electronic means b.) registering readers and responding to the PMA requests for the event via electronic means who have not registered prior to the event including validating the ebook licenses and executing the electronic financial transactions necessary to obtain the PMAs, c.) manual insertion in special cases for customers without cell phones, d.) when the signing period of the event begins, notifying the first reader for signing via electronic means that the author is ready to personally autograph the reader's book e.) the reader and the author collaborate during a unique authentication window time period during when it is guaranteed only a unique reader-author PMA is generated f.) the process repeats as the readers and the author collaborate to generate the PMAs, g.) electronically notifying readers as to how many PMAs have been completed and how long it will be until they will be serviced, h.) electronically notifying the reader for the next signing via a heads up alert that he/she is about to be serviced after the author completes the current collaboration i.) electronically notifying the reader via a NEXT message when the author is ready to collaborate for the generation of the PMA j.) signings may include hardcover books, but they will only include author autographs.

16. The PMA electronic system of claim 10 wherein the storage subsystem is used to store the PMA data in a MNH, multimedia notes and highlights, file independent of the copyrighted ebook to enable display and retrieval of the image on all the reader's devices including after archival comprises a.) identifying the position in the MNH file for storage of the PMA b.) insertion of the PMA c.) transmission to the on-line store and vault in one embodiment on the on-line store server computing device d.) storage at the on-line store and vault on the on-line store server computing device.

17. The PMA electronic system of claim 10 wherein the system is extended to other information media including but not limited to the electronic album art of audio books, MP3 audio, and DVD video products.

18. The PMA electronic system of claim 10 wherein an on-line store and vault computing device using electronic means is extended a.) to identify ebooks of interest to readers while they are browsing the on-line store inventory; b.) to identify the geographic location of the reader based on the reader profile; c.) to communicate this information to a master control server that queries the event signings database enabling the identification of matches for signing events, books of interest, and other products and services of interest; d.) and to forward one or more push invitations to the reader's device when the master control server identifies one or matches of books, local signing events, and other products and services.
